(19) United States
(12) Patent Application Publication
(10) Pub. No.: US 2026/0152103 A1
(43) Pub. Date: Jun. 4, 2026

(54) Armrest Structure

(71) Applicants: Hyundai Motor Company, Seoul (KR); Kia Corporation, Seoul (KR); Seoyon E-Hwa Co., Ltd., Anyang-Si (KR)

(72) Inventors: Ji Seob Park, Hwaseong-Si (KR); Ji Ah Kim, Hwaseong-Si (KR); Ji Yun Ha, Hwaseong-Si (KR); Jin Ho Hwang, Hwaseong-Si (KR); Jae Moon Jeong, Namyangju-Si (KR)

(21) Appl. No.: 19/186,822

(22) Filed: Apr. 23, 2025

(30) Foreign Application Priority Data
Dec. 4, 2024 (KR) 10-2024-0178791

(51) Int. Cl. B60N 2/75

(52) U.S. Cl. CPC B60N 2/773; B60N 2/767

(57) ABSTRACT

Disclosed is an armrest that includes a housing having an opening, a mount located inside the housing and deployable along the opening; a slider engaged with the mount and configured to be moved with the mount along the housing; and a driver engaged with the slider and configured to provide a driving force, to the slider and the mount, along a deployment direction of the mount.

### CROSS REFERENCE TO RELATED APPLICATION

The present application claims priority to Korean Patent Application No. 10-2024-0178791, filed on Dec. 4, 2024, the entire contents of which is incorporated herein by reference for all purposes.

### BACKGROUND

### Field

The present disclosure relates to a vehicle component, and more specifically to an armrest.

### Introduction

A vehicle may be equipped with a seat on which a passenger is seated, and the vehicle seat may be provided with an armrest on which the passenger may rest his/her arm to improve the comfort of the ride.

An armrest may be configured such that a single arm member is rotatably coupled to a seat. The seated passenger may adjust the angle of the armrest by manually rotating the armrest. However, a disadvantage of such an armrest might be that the installation angle may not be varied according to the seated position of the passenger, and the manual operation may be inconvenient.

Further, the armrest might be installed at an angle at which the user's arm may be positioned in correspondence with the seating position of the user, so a separate mounting part may need to be used if a mobile device is to be mounted or used. Furthermore, when a mounting member having a selectable angle is positioned on the armrest, the mounting member may cause damage to the mounted mobile device due to the vibration and movement of the vehicle.

The foregoing description is intended only to provide a better understanding of the background of the disclosure and should not be taken as an admission of the related art known to those having ordinary knowledge in the art.

### SUMMARY

The present disclosure has been made in an effort to solve the above-described problems associated with the related art, and an objective of the present disclosure is to provide an armrest structure in which a mounting member is located inside a housing and is selectively deployable.

Another objective of the present disclosure is to provide an armrest structure in which a slider that is moved along with a mounting member is integrated with a driver that provides a driving force to the slider.

The objectives of the disclosure are not limited to the above-mentioned objectives, and other objectives of the disclosure not mentioned may be understood from the following description with respect to embodiments of the disclosure. Furthermore, the objectives of the disclosure may be implemented by the means and combinations thereof set forth in the claims.

In an example, a mounting member may be implemented according to the use of a separate mounting part and have a setting angle that corresponds to the angle of the upper body when the user is seated.

According to one or more example embodiments of the present disclosure, an armrest may include: a housing having an opening; a mount located inside the housing and deployable along the opening; a slider engaged with the mount and configured to be moved with the mount along the housing; and a driver engaged with the slider and configured to provide a driving force, to the slider and the mount, along a deployment direction of the mount.

The armrest may further include a rack gear disposed in the housing.

The slider may include: a damper engaged with the rack gear; and a sliding bracket on which the driver and the damper are disposed.

The rack gear may include a pair of rack gears that are provided at opposite ends of the sliding bracket along a longitudinal direction of the housing.

The armrest may further include: a latch bracket disposed on the housing; and a latch disposed on the mount and is configured to, after the mount is retracted into the housing, engage with the latch bracket.

The armrest may further include a button disposed at one end of the mount adjacent to the opening. The latch may be configured to, based on an input from the button, disengage from the latch bracket.

The mount may include a hinge disposed at a rear end of the mount. The mount may be configured to rotate, along with the sliding bracket, around the hinge serving as a pivotal axis.

The mount may be configured to form, relative to the hinge: a first predetermined angle in a first state, in which the mount is retracted into the housing and stowed between the hinge and the opening, and a second predetermined angle in a second state in which the mount is deployed through the opening.

The driver may include: a spring having a first end affixed to a front end of the housing and a second end affixed to the sliding bracket; and a spring housing accommodating the spring with at least a portion, of the spring, internally wound around the spring housing.

The armrest may further include a motor located on the sliding bracket and configured to cause the spring to be wound inwardly into the spring housing during driving of the motor.

The armrest may further include a bearing disposed in the opening of the housing to face the mount.

The slider may be configured to move with the mount along a slot extending in a longitudinal direction of the housing.

According to one or more example embodiments of the present disclosure, an armrest may include: a housing having an opening; a mount located inside the housing and deployable along the opening; a hinge coupled to the mount; and a driver configured to provide a driving force, to the mount, along a moving direction of the mount. The portion of the mount may be configured to be retracted into the housing via the opening. The mount may be configured to, after a portion of the mount is exposed outside the housing via the opening, rotate around the hinge.

The armrest may further include a slider engaged with the mount and configured to be moved with the mount. The driver may be engaged with the slider.

The armrest may further include a rack gear. The slider may include: a damper engaged with the rack gear; and a sliding bracket on which the driver and the damper are disposed.

The hinge may be disposed at a rear end of the mount. The mount may be configured to rotate, along with the sliding bracket, around the hinge serving as a pivotal axis.

The armrest may further include: a latch bracket; and
a latch disposed on the mount and is configured to, after the mount is retracted into the housing, engage with the latch bracket.

The armrest may further include a button disposed at one end of the mount. The latch may be configured to, based on an input from the button, disengage from the latch bracket.

### BRIEF DESCRIPTION OF THE DRAWINGS

FIG. 1 shows an example engagement relationship

of a partition assembly and an armrest included in a seat.

FIG. 2 is a block diagram showing an example engagement relationship of a housing and an armrest cover.

FIG. 3 is a block diagram showing an example engagement relationship of the housing and a mounting member.

FIG. 4 is a side cross-sectional view showing an example armrest structure with the mounting member inserted into the housing.

FIG. 5 is a side cross-sectional view showing an example armrest structure with the mounting member deployed along a housing opening.

### DETAILED DESCRIPTION

Hereinafter, embodiments of the present

disclosure will be described in more detail with reference to the accompanying drawings. The embodiments of the present disclosure may be modified into various forms, and the scope of the present disclosure should not be construed as being limited to the following embodiments. The present embodiments are provided to more completely describe the present disclosure to an ordinary skilled person in the art.

Terms such as “. . . part”, “. . . unit”, “. . . module”, etc. described herein mean a unit portion that processes at least one function or operation, wherein the unit portion may be implemented by hardware (e.g., a processor, memory, a communication interface, an input device, an output device, etc.), software or a combination of hardware and software.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The terminology used in the specification is used to describe particular embodiments and is not intended to limit the embodiments. Expressions in the singular include the plural unless the context clearly indicates otherwise.

In addition, although the terms “first”, “second”, etc. may be used herein to distinguish elements because the name of the elements are the same, the elements are not necessarily limited to the order in the following description.

Further, as used herein, an “armrest” may include any configuration that allows the passenger seated on a seat to rest his/her arm thereon. For example, the armrest of the present disclosure may be interpreted as a structure including a console or the like.

The controller may be implemented as a memory storing data for an algorithm or a program implementing the algorithm for controlling the operations of the various components arranged in a vehicle, and a processor performing the aforementioned operations using the data stored in the memory. The memory and the processor may each be implemented as a separate chip. Alternatively, the memory and the processor may be implemented as a single chip. For example, the controller may include at least one of an electronic control unit (ECU), a central processing unit (CPU), a microprocessor unit (MPU), a micro controller unit (MCU), an application processor (AP), or any other form of processor well known in the art of the present disclosure. Further, the controller may include a combination of software and hardware capable of performing operations on at least one application or program for executing processes according to embodiments of the present disclosure.

One or more embodiments of the present disclosure will now be described in detail with reference to the accompanying drawings, wherein identical or corresponding components will be given the same drawing numerals, and a redundant description will be omitted.

In an armrest structure, a mounting member (also referred to as a mount or a device mount) positioned at an angle corresponding to a seating position of a user is deployed in response to the user's request.

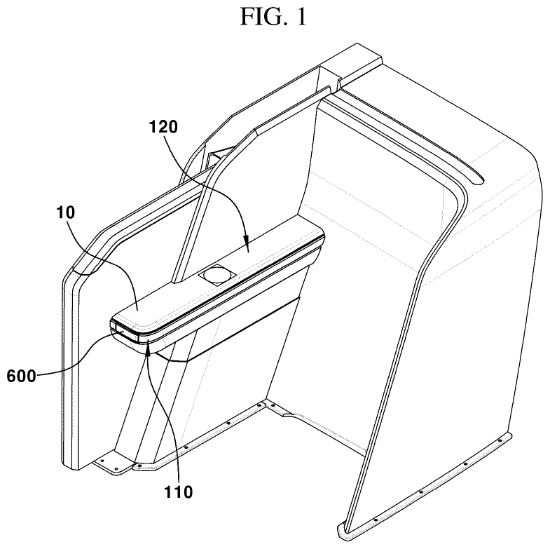

FIG. 1 is a perspective view showing an example vehicle seat including a partition-integrated armrest 10.

As illustrated, the vehicle seat (also referred to as the vehicle seat assembly) may include at least one partition assembly that partitions a seat. The partition assembly may include an armrest assembly 10 that is movable in horizontal and/or vertical direction of the vehicle.

The partition assembly may include a partition member (also referred to as a partition) provided on a frame, and a partition linker that is coupled to the partition member to allow drive force of a driver to be applied to the partition member. When the drive force of the driver is applied, the partition member may be deployed along the horizontal and/or vertical direction of the vehicle through the partition linker.

Further, the armrest assembly 10 may be optionally movably positioned along the partition member. The armrest portion of the armrest assembly 10 may support the user's arm thereon (e.g., the user's arm may be rested on the armrest portion the armrest assembly 10). The armrest portion of the armrest assembly 10 may be moved in horizontal and/or vertical direction of the vehicle if rotational force from the driver is applied thereto.

The controller may be a vehicle control unit that includes an electronic control unit (ECU) (also referred to as a seat control unit). The controller may drive the partition assembly and/or the armrest assembly 10 in response to the user's request (e.g., a user input via manipulation of a user interface such as a knob, a button, a slider, a jog stick, etc.). If a user's request is received for driving the seat reclining or deploying the partition member, the controller may apply power to the driver from the vehicle's battery.

The controller (e.g., the ECU or any other controllers to drive a driver or a motor for the movement of one or more components of the armrest assembly 10) may be implemented by having one or more electronic motors (e.g., DC motors), one or more switches, one or more relays, one or more microcontrollers, one or more memories, one or more position sensors (e.g., potentiometers, Hall effect sensors, etc.), one or more wiring harnesses that connect to an electrical system of a vehicle, etc.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

In at least some implementations, the driver and/or one or more controllers may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The seat reclining refers to the seat positioning operation in which the seatback is deployed rearwardly beyond a set angle (e.g., a threshold angle). In response to the seat reclining operation, the seat cushion may be raised at the front side so that the seat cushion forms a predetermined angle with respect to its position in the initial state.

Further, the controller may adjust a pin of a position-regulator to set the movement of the armrest assembly 10 in conjunction with, or optionally apart from, the partition member.

The armrest 10 may be provided on at least one of two sides of the seat, and have, at the front end, an opening 110 through which a mounting member may be inserted and deployed. The armrest 10 may include an upper cover 120a and a lower cover 120b (collectively referred to as a cover 120), and a housing 100 positioned between the upper cover 120a and the lower cover 120b. A mounting member (also referred to as a mount or a device mount) 200 located in the housing 100 and facing the opening 110 may include a button 600 capable of receiving the user's input. The button 600 may be located at one end of the mounting member 200 facing the opening 110.

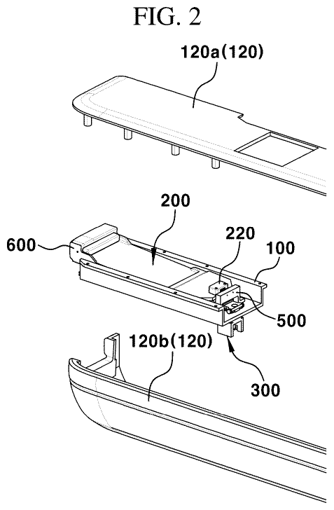

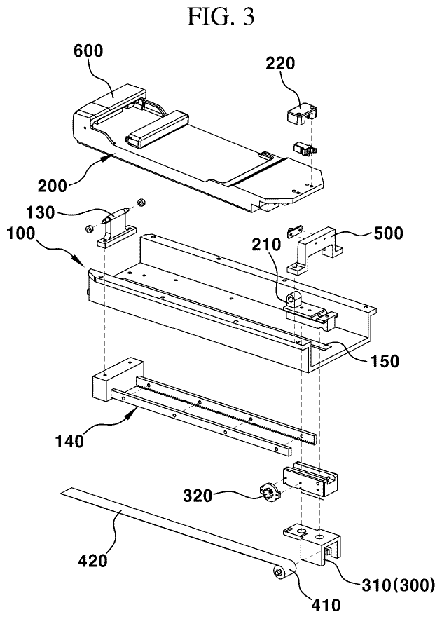

FIGS. 2 and 3 are diagrams showing an example armrest structure 10.

The armrest structure (also referred to an armrest) 10 may be located on a structure, such as a console, which may be located adjacent to the user. Further, as shown in FIG. 2, the armrest structure 10 may include an upper cover 120a and a lower cover 120b, which constitute the console-like structure, and a housing 100 that is affixed between the upper cover 120a and the lower cover 120b. The housing 100 may have the opening 110 at the front end. A mounting member 200 may be positioned in the opening 110. The mounting member 200 may be mounted and positioned inside the housing 100 so as to have (e.g., form) a first set (e.g., predetermined) angle relative to the opening 110 and a hinge 210 of the housing 100.

As shown in FIG. 3, the armrest structure 10 may include a slider 300 that is movable in a front-to-back (e.g., longitudinal) direction of the housing 100 along with the mounting member 200. The armrest structure may include a driver 400 provided on the slider 300 to provide a longitudinal movement force.

A hinge 210 may be rotatably coupled to the mounting member 200 such that the front end of the hinge 210 is positioned on the top surface of the housing 100 to face the opening 110, and the rear end of the hinge 210 is coupled to the slider 300. Furthermore, the mounting member 200 may include a latch 220 on the rear side at a position facing a latch bracket 500 secured to the housing 100. Further, the mounting member 200 may be provided with a holder for securing (e.g., mounting) a device (e.g., a mobile device). The holder may secure (e.g., mount) the device with, for example, a clamp, a fastener, a magnet, etc. The holder may be secured to one side of the mounting member 200 to apply elastic force to secure the mobile device, or to force the mobile device to be held on the mounting member 200 via a linkage structure.

The latch 220 may be disengaged from the latch bracket 500 if the button 600 is pressed, and although not illustrated, the button 600 may include a plurality of linkages such that the latch 220 may be rotationally opened to disengage from the latch bracket 500. Alternatively, the latch 220 may include a push-pull type engagement structure so that the latch 220 is unlocked in response to a pressing action of the button 600.

Rack gears 140 (also referred to as a rack and pinion) may be provided at the bottom of the housing 100 along the longitudinal direction. The rack gears 140 may be provided in a pair at both widthwise ends of the housing 100, and the slider 300 is movable in the longitudinal direction of the housing 100 along the rack gears 140. The slider 300 may be configured to allow the hinge 210, which is provided on the top surface of the housing 100, and the sliding bracket 310 and the driver 400, which are provided at the bottom of the housing 100, to be movable, as a single body, along a slot 150 of the housing 100. The hinge 210 may be positioned above the slot 150 and the sliding bracket 310 may be positioned below the slot 150, so that the deployment of the mounting member 200 is configured to correspond to the length of the slot 150.

The slider 300 may include a damper 320 that is engaged with the rack gear 140, and a sliding bracket 310 that secures the damper 320 and the driver 400. Furthermore, the sliding bracket 310 may be engaged through the housing 100 with the hinge 210, which is secured to the mounting member 200 at the bottom of the housing and to the rear end of the mounting member 200 at the top surface of the housing 100. Thus, the slider 300, the hinge 210, and the mounting member 200 may be operable as a single unit.

The damper 320 may be engaged with the rack gear 140 to control the deployment speed of the mounting member 200 in response to the drive force from the driver 400. The damper 320 may include an eccentric damper, a fluid damper, or the like, and may be coupled to the sliding bracket 310 for rotation along the rack gear 140.

The driver 400 may include a spring 420 fixed to a front end of the housing 100, and a spring housing 410 around which the spring 420 is internally wound, and the spring housing 410 is fixedly positioned on the sliding bracket 310. The driver 400 may include a motor, a servo, etc. that is capable of mechanically move one or more components (e.g., the mounting member 200, the slider 300, etc.).

The spring 420 may be deployed and positioned between the housing 100 and the sliding bracket 310 in a state in which the mounting member 200 is retracted into the housing 100 (e.g., a retracted position of the mounting member 200). Thus, the spring 420 may apply a tension to the slider 300 in the direction in which the spring 420 is internally wound around the spring housing 410. In other words, when the mounting member 200 is mounted in the housing 100, the spring 420 may apply elastic force to the slider 300 in the direction in which the mounting member 200 is deployed.

Alternatively, the spring 420 may be wound or unfolded by a motor coupled to the spring housing 410, and the mounting member 200 may be deployed from or mounted in the housing 100 depending on the driving direction of the motor.

If the driver 400 is moved in a direction in which the spring 420 is wound, the mounting member 200 may be deployed out of the armrest assembly along the opening 110 of the housing 100. Furthermore, if an external force or motor drive force is applied in the direction in which the spring 420 is deployed, the latch 220 may be fastened to the latch bracket 500 to keep the mounting member 200 retracted in the housing 100.

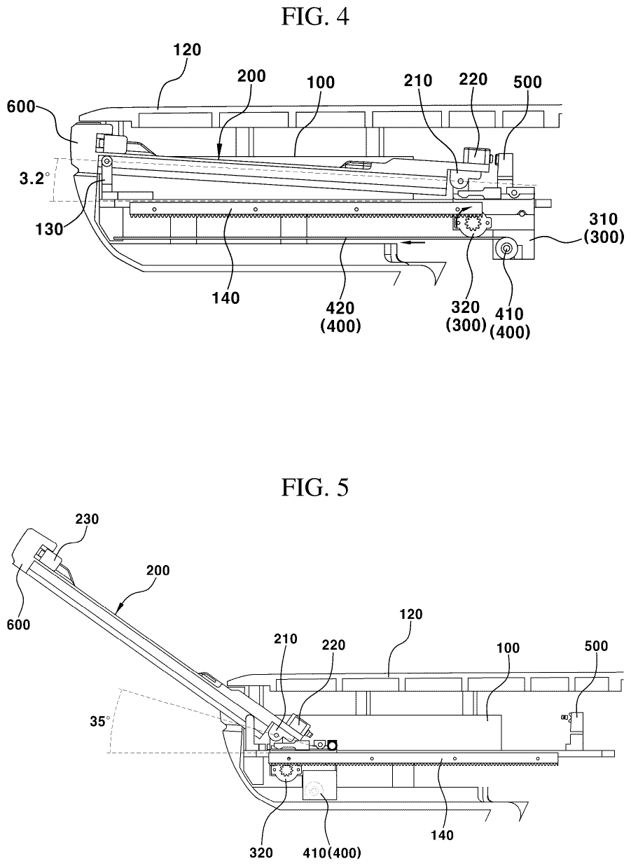

FIG. 4 is a side cross-sectional view showing the mounting member 200 retracted into the interior of the housing 100.

The cover 120 constituting the armrest assembly may include the upper cover 120a and the lower cover 120b (collectively, the cover 120), and the housing 100 may be secured to the upper cover 120a and the lower cover 120b. The housing 100 may be partially secured to the cover 120, and the housing may have the opening 110 on the side through which the mounting member 200 is deployed. The opening 110 may be provided through both the cover 120 and the housing 100, and may be positioned such that the button 600 of the mounting member 200 is exposed through the opening 110 with the mounting member 200 retracted into the housing 100.

With the mounting member 200 retracted, the slider 300 may be positioned adjacent an inner side of the housing 100 away from the opening 110. Furthermore, the driver 400 may be fixedly positioned on the slider 300 with the spring 420 deployed. The spring 420 may be coupled, at a first end, to the housing 100 or cover 120 adjacent the opening 110, and is at least partially wound in the spring housing 410 at a second end. The spring 420 may be engaged with a rotating shaft of a motor within the spring housing 410 to receive the driving force. Alternatively, the spring 420 may be subjected to a rotational force by a helical spring formed within the spring housing 410, and a tension may be applied to the spring 420 in a direction in which the spring 420 is wound inwardly into the spring housing 410.

Furthermore, the damper 320 of the slider 300 may be engaged with the rack gears 140, which are provided in a pair on both sides of the spring housing 410 to extend in the longitudinal direction of the housing 100. The damper 320 may provide resistance to decrease the deployment speed of the mounting member 200 as the damper moves along the longitudinal direction of the rack gears 140 in response to movement of the mounting member 200.

Further, the hinge 210 may engage with the sliding bracket 310. The hinge 210 may be positioned at a distal end in the deployment direction of the mounting member 200. The hinge 210 may be positioned so that one side deployed relative to an inner end of the cover 120 rotates vertically.

In addition, the position of the bearing 130 and the hinge 210 provided in the housing 100 adjacent the opening 110 may set an angle of the mounting member 200 relative to the longitudinal direction of the housing 100. The mounting member 200 formed by the bearing 130 and the hinge 210 in the retracted state may be configured to have (e.g., form) a first set (e.g., predetermined) angle. The first set angle may be, for example, 3.2 degrees along a height direction relative to the longitudinal direction of the housing 100. The mounting member 200 may be stowed between the hinge 210 and the opening 110 in the retracted state.

The latch bracket 500 may be provided in the housing 100 so as to be interlocking with an inner end of the mounting member 200. The mounting member 200 may include the latch portion 220 at one end facing the latch bracket 500. The latch 220 may include a push-pull type engagement structure, so that the latch 220 and the latch bracket 500 may be engaged or disengaged in response to pressing of the button 600.

Thus, even when the latch 220 is engaged with the latch bracket 500, the spring 420 of the driver 400 may apply tension to the mounting member 200 and the slider 300 in a direction in which the slider 300 is approaching the opening 110. Furthermore, when the latch 220 is disengaged from the latch bracket 500 in response to the unlocking input of the button 600, the mounting member 200 may be deployed out of the opening 110 by the tension of the spring 420.

FIG. 5 is a side cross-sectional view showing the armrest structure 10 with the mounting member 200 deployed.

In response to an input from the user button 600 or an input of deploying the mounting member 200 from the controller, the mounting member 200 may be deployed along the opening 110 of the housing 100. Further, the latch 220 may be disengaged from the latch bracket 500, and the disengaged mounting member 200 may slide along the slot 150 of the housing 100 toward the front side where the opening 100 is located in conjunction with the slider 300 by the tension of the driver 400.

Furthermore, with the mounting member 200 retracted into the housing 100, the front side of the spring 420 may be secured to the housing 100 or cover 120 adjacent the opening 110, and the elastic force of the deployed spring 420 elastically returning to the spring housing 410 may be applied to the slider 300. Thus, the elastic force applied in the direction of winding of the spring 420 inwardly of the spring housing 410 causes the mounting member 200, the slider 300, and the driver 400 coupled to the slider 300 to be moved together to the front side of the housing 100.

Furthermore, the hinge 210 located on the upper surface of the housing 100 at an end of the mounting member 200 may be engaged with the sliding bracket 310 located at the bottom of the housing 100 relative to the slot 150 in the housing 100, so the mounting member 200 is deployed outwardly of the opening 110 along the shape of the slot 150.

Furthermore, the bearing 130 and the hinge 210 may be provided in close proximity along the longitudinal direction of the housing 100 compared to the retracted state of the mounting member 200, and the difference in height between the bearing 130 and the hinge 210 may cause the mounting member 200 to be deployed outwardly of the opening 110 to have (e.g., form) a second set (e.g., predetermined) angle. The second set angle may be, for example, set to 35 degrees. However, the second set angle may be varied depending on the position of the armrest structure 10, so the second set angle may be varied with the height difference between the bearing 130 and the hinge 210.

The damper 320 may be configured to rotate in contact with the rack gears 140 as the slider 300 is moved toward the front side of the housing 100. Based on the friction force generated between the damper 320 and the rack gears 140 and the rotational resistance of the resistive fluid provided in the damper 320, an operation force may be applied in the direction against the force applied to the mounting member 200 from the driver 400. Thus, the damper 320 may control the deployment speed of the mounting member 200.

In an aspect of the present disclosure, an armrest structure includes: a housing having an opening; a mounting member located inside the housing and deployable along the opening; a slider engaged with the mounting member so as to be moved along with the mounting member along the housing; and a driver engaged with the slider so as to provide a driving force along the deployment direction of the mounting member.

The armrest structure may further include a rack gear located in the housing.

The slider may include: a damper engaged with the rack gear; and a sliding bracket on which the driver and the damper are located.

The rack gears may be provided in a pair at opposite ends of the sliding bracket along the longitudinal direction of the housing.

The armrest structure may further include: a latch bracket located on the housing; and a latch located on the mounting member and engaged with the latch bracket when the mounting member is retracted into the housing.

The armrest structure may include a button located at one end of the mounting member adjacent the opening, wherein the latch is disengaged from the latch bracket in response to the button's input.

The armrest structure may further include a hinge located, as a pivotal axis of the mounting member, at a rear end of the mounting member so as to be moved along with the sliding bracket.

The mounting member may be configured to have a first set angle relative to the hinge in a state of being mounted between the hinge and the opening and a second set angle relative to the hinge in a state of being deployed.

The driver may include: a spring having a first end fixed to a front end of the housing and a second end fixed to the sliding bracket; and a spring housing accommodating the spring with at least a portion of the spring internally wound around the spring housing.

The armrest structure may include a motor located on the sliding bracket so as to cause the spring to be wound inwardly into the spring housing during driving of the motor.

The armrest structure may further include a bearing located in the opening of the housing to face the mounting member.

The slider may be moved along with the mounting member along a slot extending in the longitudinal direction of the housing.

The present disclosure has the following effects by the combination and use relationships of the configurations of embodiments described below.

The armrest structure is configured such that the mounting member is deployable at a selectable angle, thereby providing the configuration operable in response to the user's position.

The armrest structure is configured such that when not in use, the mounting member is accommodated inside the housing, thereby improving the aesthetics of the armrest structure.

The foregoing detailed description is illustrative of the present disclosure. In addition, the above description shows and describes preferred embodiments of the present disclosure, and the present disclosure may be used in various other combinations, modifications, and environments. That is, changes or modifications may be made within the scope of the concept of the disclosure disclosed herein, the equivalent scope to the disclosed content, and/or the skill or knowledge in the art. The described embodiment illustrates the best mode for implementing the technical idea of the present disclosure, and various changes required in the specific application fields and uses of the present disclosure are possible. Therefore, the detailed description of the present disclosure is not intended to limit the disclosure to the disclosed embodiment. In addition, the appended claims should be construed as including other embodiments.

What is claimed is:

1. An armrest comprising:
a housing having an opening;
a mount located inside the housing and deployable along the opening;
a slider engaged with the mount and configured to be moved with the mount along the housing; and
a driver engaged with the slider and configured to provide a driving force, to the slider and the mount, along a deployment direction of the mount.

2. The armrest of claim 1, further comprising a rack gear disposed in the housing.

3. The armrest of claim 2, wherein the slider comprises:
a damper engaged with the rack gear; and
a sliding bracket on which the driver and the damper are disposed.

4. The armrest of claim 3, wherein the rack gear comprises a pair of rack gears that are provided at opposite ends of the sliding bracket along a longitudinal direction of the housing.

5. The armrest of claim 1, further comprising:
a latch bracket disposed on the housing; and
a latch disposed on the mount and is configured to, after the mount is retracted into the housing, engage with the latch bracket.

6. The armrest of claim 5, further comprising a button disposed at one end of the mount adjacent to the opening, wherein the latch is configured to, based on an input from the button, disengage from the latch bracket.

7. The armrest of claim 3, wherein the mount comprises a hinge disposed at a rear end of the mount, wherein the mount is configured to rotate, along with the sliding bracket, around the hinge serving as a pivotal axis.

8. The armrest of claim 7, wherein the mount is configured to form, relative to the hinge:
a first predetermined angle in a first state, in which the mount is retracted into the housing and stowed between the hinge and the opening, and
a second predetermined angle in a second state in which the mount is deployed through the opening.

9. The armrest of claim 3, wherein the driver comprises:
a spring having a first end affixed to a front end of the housing and a second end affixed to the sliding bracket;
and a spring housing accommodating the spring with at least a portion, of the spring, internally wound around the spring housing.

10. The armrest of claim 9, further comprising a motor located on the sliding bracket and configured to cause the spring to be wound inwardly into the spring housing during driving of the motor.

11. The armrest of claim 1, further comprising a bearing disposed in the opening of the housing to face the mount.

12. The armrest of claim 1, wherein the slider is configured to move with the mount along a slot extending in a longitudinal direction of the housing.

13. An armrest comprising:
a housing having an opening;
a mount located inside the housing and deployable along the opening;
a hinge coupled to the mount, wherein the mount is configured to, after a portion of the mount is exposed outside the housing via the opening, rotate around the hinge; and
a driver configured to provide a driving force, to the mount, along a moving direction of the mount, wherein the portion of the mount is configured to be retracted into the housing via the opening.

14. The armrest of claim 13, further comprising a slider engaged with the mount and configured to be moved with the mount,
wherein the driver is engaged with the slider.

15. The armrest of claim 14, further comprising a rack gear,
wherein the slider comprises:
a damper engaged with the rack gear; and
a sliding bracket on which the driver and the damper are disposed.

16. The armrest of claim 15, wherein the hinge is disposed at a rear end of the mount, wherein the mount is configured to rotate, along with the sliding bracket, around the hinge serving as a pivotal axis.

17. The armrest of claim 13, further comprising:
a latch bracket; and
a latch disposed on the mount and is configured to, after the mount is retracted into the housing, engage with the latch bracket.

18. The armrest of claim 17, further comprising a button disposed at one end of the mount, wherein the latch is configured to, based on an input from the button, disengage from the latch bracket.
